(19) United States
(12) Patent Application Publication
(10) Pub. No.: US 2024/0142854 A1
(43) Pub. Date: May 2, 2024

(54) OPTICAL ELEMENT DRIVING MECHANISM

(71) Applicant: TDK TAIWAN CORP., Taoyuan City (TW)

(72) Inventors: Chia-Che WU, Taoyuan City (TW); Chao-Chang HU, Taoyuan City (TW); Yu-Chiao LO, Taoyuan City (TW)

(21) Appl. No.: 18/495,556

(22) Filed: Oct. 26, 2023

Related U.S. Application Data
(60) Provisional application No. 63/420,236, filed on Oct. 28, 2022.

(51) Int. Cl. G03B 5/00; G02B 27/64; G03B 13/36

(52) U.S. Cl. CPC G03B 5/00; G02B 27/646; G03B 13/36; G03B 2205/0069

(57) ABSTRACT

An optical element driving mechanism is for accommodating a first optical element and includes a fixed assembly, a movable part and a driving assembly. The movable part is configured to connect a second optical element, the second optical element corresponds to the first optical element, and the movable part is movable relative to the fixed assembly. The driving assembly is configured to drive the movable part to move relative to the fixed assembly. The fixed assembly includes a first accommodating space configured to accommodate the first optical element.

### CROSS REFERENCE TO RELATED APPLICATIONS

This application claims the benefit of U.S. Provisional Application No. 63/420,236, filed Oct. 28, 2022, the entirety of which is incorporated by reference herein.

### BACKGROUND OF THE INVENTION

### Field of the Disclosure

The present disclosure relates to an optical element driving mechanism, and in particular it relates to an optical element driving mechanism with a long focal length and anti-shake function.

### Description of the Related Art

As technology has developed, many of today's electronic devices (such as smartphones) have a camera and video functionality. Using the camera modules disposed on electronic devices, users can operate their electronic devices to capture photographs and record videos.

Today's design of electronic devices continues to follow the trend of miniaturization, meaning that the various components of the camera module and its structure must also be continuously reduced, so as to achieve miniaturization. In general, the driving mechanism of a camera module has a camera lens holder configured to hold a camera lens, and the driving mechanism can have the functions of auto focusing or optical image stabilization. However, although existing driving mechanisms can achieve the aforementioned functions of photographing and video recording, they still cannot meet all the needs of users.

Therefore, how to design a camera module capable of performing autofocus and optical anti-shake functions while at the same time achieving miniaturization are topics nowadays that need to be discussed and solved.

### BRIEF SUMMARY OF THE INVENTION

Accordingly, one objective of the present disclosure is to provide an optical element driving mechanism to solve the above problems.

According to some embodiments of the disclosure, an optical element driving mechanism is provided for accommodating a first optical element and including a fixed assembly, a movable part and a driving assembly. The movable part is configured to connect a second optical element, the second optical element corresponds to the first optical element, and the movable part is movable relative to the fixed assembly. The driving assembly is configured to drive the movable part to move relative to the fixed assembly. The fixed assembly includes a first accommodating space configured to accommodate the first optical element.

According to some embodiments, the movable part includes a second accommodation space configured to accommodate the first optical element. The second accommodation space is located in the first accommodation space. The second optical element defines an optical axis. The optical axis passes through the second optical element and the first optical element. When viewed along the optical axis, the movable part has a long strip-shaped structure.

According to some embodiments, the movable part further includes a first side wall, a second side wall and a first opening. When viewed along the optical axis, the first side wall is located on one side of the first optical element. When viewed along the optical axis, the second side wall is located on other side of the first optical element. When viewed along the optical axis, the first optical element is located between the first side wall and the second side wall. The first opening corresponds to the first optical element. When viewed along a first axis, at least a portion of the first optical element is exposed from the first opening. The first axis is not parallel to the optical axis.

According to some embodiments, the movable part further includes a top wall and a second opening. The top wall corresponds to the second optical element. The second opening corresponds to the second optical element and is located on the top wall. The optical axis passes through the second opening. The movable part further includes a third side wall and a fourth side wall. The third side wall is connected between the first side wall and the top wall. The fourth side wall is connected between the second side wall and the top wall. When viewed along the first axis, the third side wall and the fourth side wall each have an L-shaped structure.

According to some embodiments, the fixed assembly further includes a base and an outer frame. The outer frame is fixedly connected to the base to form the first accommodation space. The base has a base plate with a plate-shaped structure. The fixed assembly further includes a first supporting portion which is disposed on the base to accommodate the first optical element. The first supporting portion extends and protrudes along the first axis from the base plate. The first optical element is fixedly connected to the first supporting portion. The movable part is movable relative to the first optical element.

According to some embodiments, the movable part further includes a rear side wall which is connected between the first side wall and the second side wall. When viewed along the first axis, there is a gap between the rear side wall and the outer frame. When viewed along the first axis, the movable part encloses the first optical element. The movable part does not directly contact the base.

According to some embodiments, a first accommodation perforation and a second accommodation perforation are formed on the rear side wall. The driving assembly includes a first driving element and a second driving element, which are respectively arranged in the first accommodation perforation and the second accommodation perforation. When viewed along the first axis, the first driving element and the second driving element are not exposed from the rear side wall. When viewed along the optical axis, the first driving element and the second driving element are exposed from the rear side wall. The first driving element and the second driving element are configured to drive the movable part to rotate around a first rotation axis or a second rotation axis, so that a pushing portion of the second optical element pushes a main body of the second optical elements to change the optical properties of the second optical element. North-pole and South-pole of each of the first driving element and the second driving element are arranged along the first axis.

According to some embodiments, the optical element driving mechanism further includes a circuit assembly fixedly disposed on the base of the fixed assembly. The circuit assembly has a first circuit portion which is fixedly disposed on the first supporting portion and faces the rear side wall. The driving assembly further includes a first coil and a second coil, which are disposed on the first circuit portion and respectively correspond to the first driving element and the second driving element. When viewed along the optical axis, the first circuit portion has a T-shaped structure. When viewed along the first axis, the first coil and the second coil are located between the movable part and the first supporting portion. When viewed along the first axis, the first coil and the second coil are arranged along a second axis. The second axis is perpendicular to the first axis and the optical axis.

According to some embodiments, the circuit assembly further has a second circuit portion which is connected to the first circuit portion. The driving assembly further includes a third coil and a fourth coil, which are disposed on the second circuit portion and respectively correspond to the first driving element and the second driving element. When viewed along the second axis, the third coil and the fourth coil are located between the circuit assembly and the movable part. When viewed along the first axis, the third coil and the fourth coil are arranged along the second axis. When viewed along the first axis, the rear side wall overlaps a portion of the third coil and the fourth coil. When viewed along the first axis, the first coil overlaps a portion of the third coil. When viewed along the first axis, the second coil overlaps a portion of the fourth coil.

According to some embodiments, when the first coil and the second coil respectively act with the first driving element and the second driving element, the first driving element and the second driving element drive the movable part to rotate around the second rotation axis relative to the base. When the third coil and the fourth coil respectively act with the first driving element and the second driving element, the first driving element and the second driving element drive the movable part to rotate around the first rotation axis relative to the base. The first rotation axis is perpendicular to the second rotation axis.

According to some embodiments, a first accommodation hole and a second accommodation hole are formed on the base plate and respectively accommodate the third coil and the fourth coil. The first accommodation hole and the second accommodation hole penetrate the base plate. When viewed along the first axis, the rear side wall overlaps the first accommodation hole and the second accommodation hole. When viewed along the first axis, the first coil and the third coil are symmetrical to the second coil and the fourth coil.

According to some embodiments, when viewed along the first axis, a long side of the first coil and a long side of the third coil extend along the second axis. When viewed along the first axis, the length of the first coil along the second axis is different from the length of the third coil along the second axis. When viewed along the first axis, the length of the first coil along the second axis is less than the length of the third coil along the second axis. When viewed along the first axis, the length of the first driving element along the second axis is different from the length of the first coil along the second axis. When viewed along the first axis, the length of the first driving element along the second axis is less than the length of the first coil along the second axis.

According to some embodiments, when viewed along the first axis, the width of the rear side wall along the optical axis is different from the width of the third coil along the optical axis. When viewed along the first axis, the width of the rear side wall along the optical axis is smaller than the width of the third coil along the optical axis. When viewed along the second axis, a gap is formed between the movable part and the base plate along the first axis. When viewed along the second axis, the base plate forms a bottom groove configured to accommodate a portion of the circuit assembly.

According to some embodiments, the optical element driving mechanism further includes a connecting assembly, and the movable part is movably connected to the fixed assembly through the connecting assembly. The connecting assembly includes a first elastic member and a second elastic member. The first elastic member and the second elastic member respectively have a first flexible portion and a second flexible portion. The first flexible portion has flexibility. The second flexible portion has flexibility. When viewed along the optical axis, the first flexible portion and the first optical element are arranged along the second axis. When viewed along the optical axis, a longitudinal axis of the movable part having a long strip-shaped structure is parallel to the second axis. When viewed along the optical axis, the first flexible portion and the second flexible portion are arranged along the second axis. When viewed along the optical axis, a center of the second optical element is located between the first flexible portion and the second flexible portion.

According to some embodiments, the first elastic member has a first connecting end which is fixedly connected to the fixed assembly. The first connecting end is affixed to a first setting portion of the fixed assembly. The first elastic member further has a second connecting end which is fixedly connected to the movable part. The first flexible portion is connected between the first connecting end and the second connecting end. The second elastic member has a third connecting end which is fixedly connected to the fixed assembly. The third connecting end is affixed to a second setting portion of the fixed assembly. The second elastic member further has a fourth connecting end which is fixedly connected to the movable part. The second flexible portion is connected between the third connecting end and the fourth connecting end.

According to some embodiments, when viewed along the optical axis, the first setting portion, the second optical element and the second setting portion are arranged along the second axis. The third side wall and the fourth side wall each has a recessed structure. The third side wall and the fourth side wall respectively correspond to the first setting portion and the second setting portion. The first setting portion and the second setting portion each has a columnar structure extending along the first axis from the base plate. The first setting portion and the second setting portion do not contact the movable part and the first supporting portion. The first setting portion, the second setting portion, the first supporting portion and the base plate are integrally formed in one piece. When viewed along the first axis, in the direction of the optical axis or the second axis, the third side wall is located between the first setting portion and the first supporting portion, and the fourth side wall is located between the second setting portion and the first supporting portion.

According to some embodiments, when viewed along the optical axis, the first rotation axis is located between the first flexible portion and the second flexible portion. When viewed along the optical axis, the second rotation axis passes through the first flexible portion and the second flexible portion. The first optical element and the second optical element have different materials. The first optical element and the second optical element have different material states. The second optical element is a liquid lens. The first optical element includes a solid lens. The second optical element further includes an optical fixed portion. The optical fixed portion is fixedly connected to the fixed assembly. The optical fixed portion is affixed to the fixed assembly by laser welding. The optical axis passes through the main body. The pushing portion has a ring-shaped structure. The pushing portion is fixedly connected to the movable part. When viewed along the optical axis, the optical fixed portion overlaps at least a portion of the connecting assembly.

According to some embodiments, the fixed assembly further includes a third opening. The third opening corresponds to the second optical element. The third opening corresponds to the first optical element. When viewed along the optical axis, the third opening is larger than the second opening.

According to some embodiments, the outer frame has a first outer wall and a second outer wall. The first outer wall and the second outer wall each have a plate-shaped structure. The third opening is formed by the first outer wall and the second outer wall. The first outer wall and the second outer wall are perpendicular to each other. An external light is incident on the third opening in a first direction and is emitted from the third opening in a second direction. The first direction and the second direction are not parallel to each other.

According to some embodiments, a first surface of the first side wall faces the first optical element. A second surface of the first side wall and the first surface face in opposite directions. There is a gap between the first surface and the fixed assembly. There is another gap between the second surface and the fixed assembly. A third surface of the second side wall faces the first optical element. A fourth surface of the second side wall and the third surface face in opposite directions. There is another gap between the third surface and the fixed assembly. There is another gap between the fourth surface and the fixed assembly. The third surface faces the first surface. The fixed assembly further includes a fourth opening corresponding to the second optical element. When viewed along the first axis, the third opening overlaps at least a portion of the fourth opening. The fourth opening is located at the base.

The present disclosure provides an optical element driving mechanism, which can be a periscope lens mechanism, including a fixed assembly, a driving assembly, a movable part and a connecting assembly. The movable part is movably connected to the base of the fixed assembly through the connecting assembly, and the movable part surrounds the first optical element. The optical fixed portion of the second optical element is affixed to the outer frame of the fixed assembly, and the pushing portion is fixedly connected to the movable part.

The driving assembly is configured to drive the movable part to move relative to the base and the first optical element to drive the pushing portion to push the thin film and the liquid, thereby changing the optical properties of the second optical element, so as to achieve the purpose of optical image stabilization. Because there is a gap between the movable part and the base, the movable part does not collide with the base and cause damage when rotating.

It is worth noting that the driving assembly only includes two driving elements (the magnets), and the first coil to the fourth coil share the two driving elements. Therefore, such a configuration can reduce the overall volume of the optical element driving mechanism to achieve miniaturization. In addition, because the number of magnets is reduced, the purpose of weight reduction can also be further achieved.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an optical element driving mechanism 100 according to an embodiment of the present disclosure.

FIG. 2 is an exploded diagram of a partial structure of the optical element driving mechanism 100 according to an embodiment of the present disclosure.

FIG. 3 is a cross-sectional view of the optical element driving mechanism 100 along line A-A in FIG. 1 according to an embodiment of the present disclosure.

FIG. 4 is a top view of the first optical module 100A according to an embodiment of the present disclosure.

FIG. 5 is a font view of the first optical module 100A according to an embodiment of the present disclosure.

FIG. 6 is a bottom view of the first optical module 100A according to an embodiment of the present disclosure.

FIG. 7 is a bottom view of the first optical module 100A according to an embodiment of the present disclosure.

FIG. 8 is a cross-sectional view of the second optical element OE2 along line B-B in FIG. 5 according to an embodiment of the present disclosure.

FIG. 9 is a perspective view of the first optical module 100A according to an embodiment of the present disclosure.

FIG. 10 and FIG. 11 are schematic three-dimensional diagrams illustrating that the driving assembly DA drives the movable part 108 to rotate around different axes according to an embodiment of the present disclosure.

FIG. 12 is a side view of a partial structure of the first optical module 100A according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

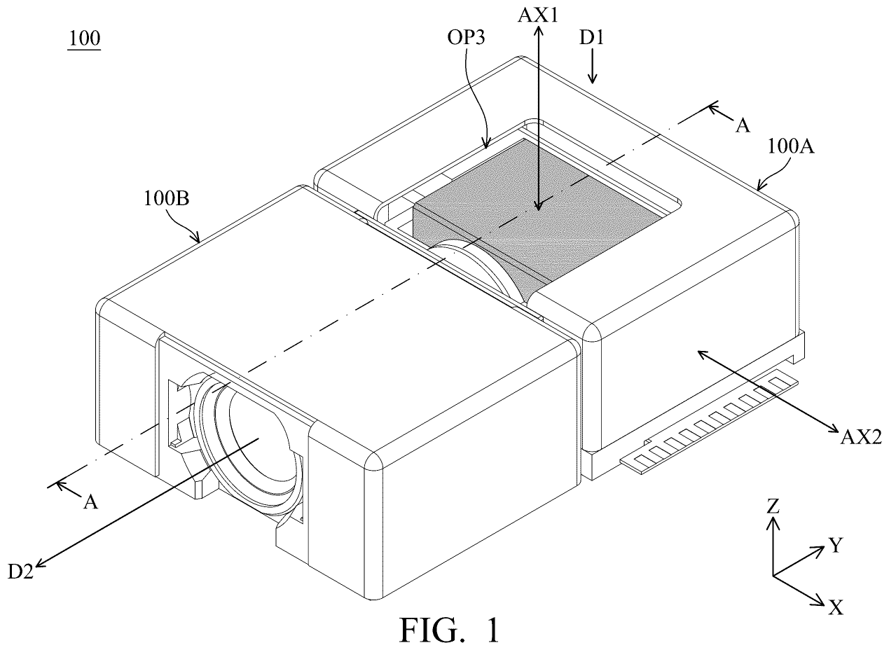

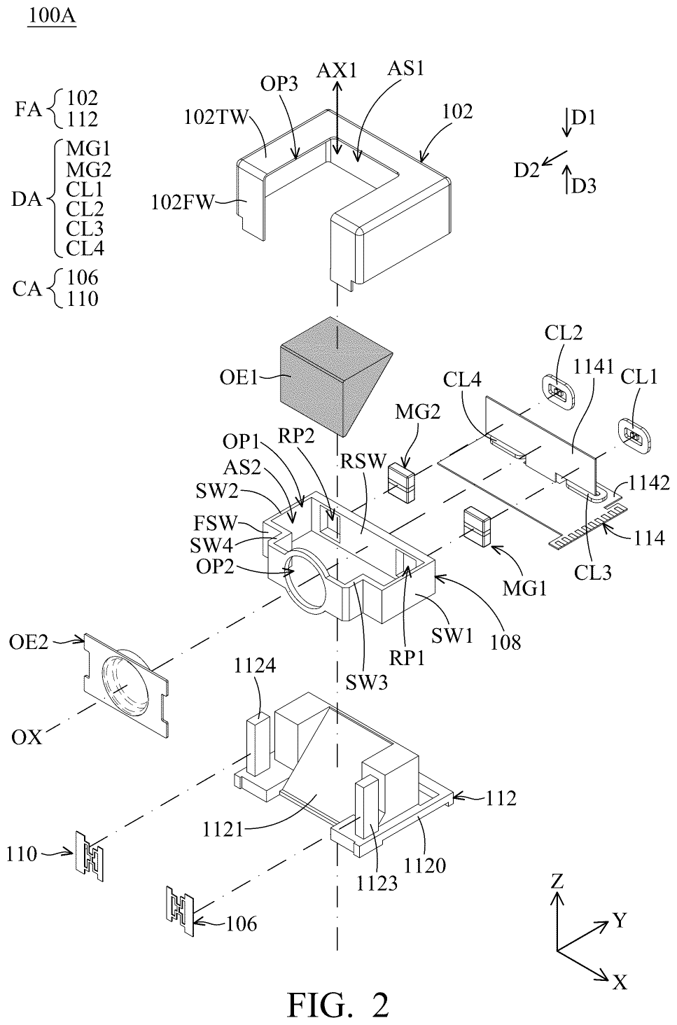

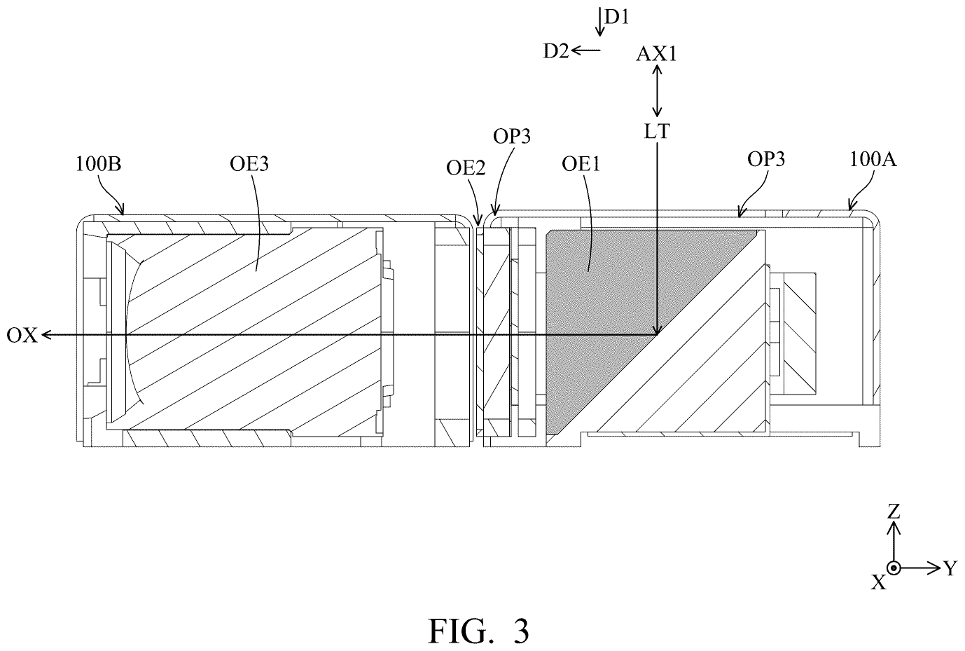

Please refer to FIG. 1 to FIG. 3. FIG. 1 is a schematic diagram of an optical element driving mechanism 100 according to an embodiment of the present disclosure, FIG. 2 is an exploded diagram of a partial structure of the optical element driving mechanism 100 according to an embodiment of the present disclosure, and FIG. 3 is a cross-sectional view of the optical element driving mechanism 100 along line A-A in FIG. 1 according to an embodiment of the present disclosure. The optical element driving mechanism 100 can be an optical camera system and can be configured to hold and drive an optical element. The optical element driving mechanism 100 can be installed in various electronic devices or portable electronic devices, such as a smartphone, for allowing a user to perform the image capturing function. In this embodiment, the optical element driving mechanism 100 can be a voice coil motor (VCM) with an auto-focusing (AF) function, but it is not limited thereto. In other embodiments, the optical element driving mechanism 100 can also perform the functions of auto-focusing and optical image stabilization (OIS).

In this embodiment, the optical element driving mechanism 100 may include a first optical module 100A and a second optical module 100B. An external light LT enters the first optical module 100A along a first axis AX1 (the Z-axis) and is reflected by a first optical element OE1, then passes through a second optical element OE2 and is emitted from a third optical element OE3 of the second optical module 100B.

The first optical module 100A may have autofocus (AF) and/or optical image stabilization (OIS) functions, and the second optical module 100B may be a fixed lens, or may also have autofocus (AF) and/or optical image stabilization (OIS) functions. In other words, the functions of the two optical modules can be selected and matched with each other according to actual needs.

As shown in FIG. 2, the first optical module 100A may include a fixed assembly FA, a movable part 108, and a driving assembly DA. The movable part 108 is configured to be connected to the second optical element OE2. The second optical element OE2 corresponds to the first optical element OE1, and the movable part 108 is movable relative to the fixed assembly FA. The driving assembly DA is configured to drive the movable part 108 to move relative to the fixed assembly FA.

In this embodiment, as shown in FIG. 2, the fixed assembly FA includes an outer frame 102 and a base 112. The outer frame 102 is fixedly connected to the base 112 and forms a first accommodation space AS1 which is configured to accommodate the first optical element OE1. The first optical element OE1 may be a reflective prism, but it is not limited thereto.

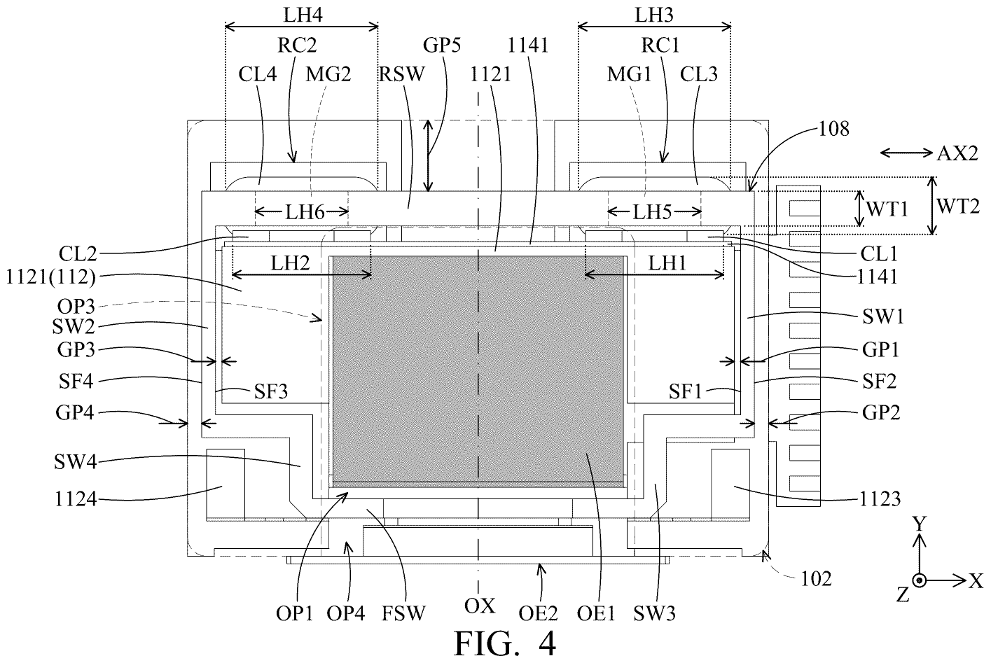

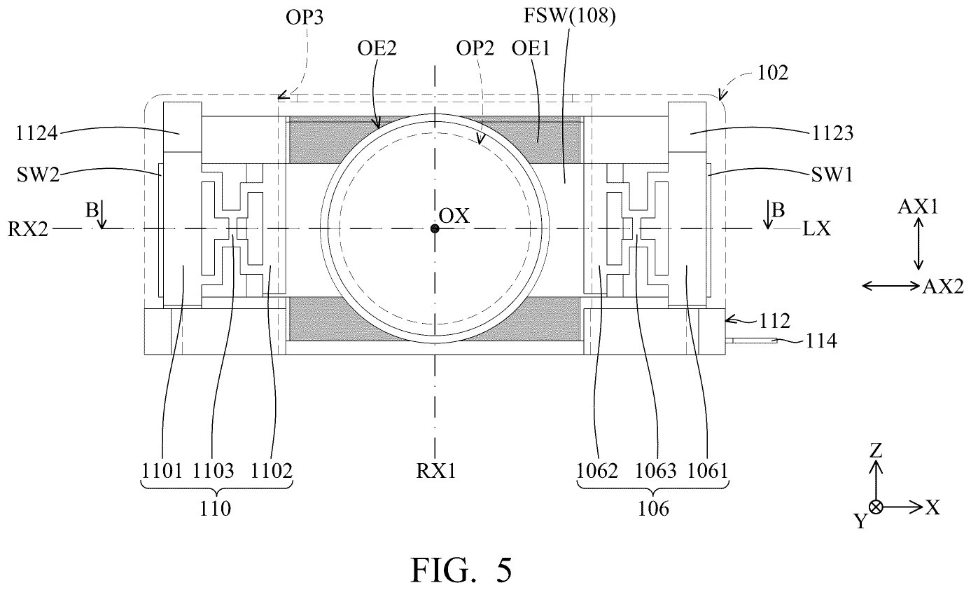

Please refer to FIG. 1 to FIG. 5. FIG. 4 is a top view of the first optical module 100A according to an embodiment of the present disclosure, and FIG. 5 is a font view of the first optical module 100A according to an embodiment of the present disclosure. It should be noted that, in order to clearly represent the internal structure, the outer frame 102 in the figures is drawn with a dotted line, which does not mean that the outer frame 102 does not exist. The following figures are the same.

As shown in FIG. 2 and FIG. 4, the movable part 108 may include a second accommodation space AS2 configured to accommodate the first optical element OE1, and the second accommodation space AS2 is located in the first accommodation space AS1.

In this embodiment, the second optical element OE2 may define an optical axis OX, and the optical axis OX passes through the second optical element OE2 and the first optical element OE1. As shown in FIG. 2 and FIG. 5, when viewed along the optical axis OX, the movable part 108 has a long strip-shaped structure.

Furthermore, the movable part 108 may include a first side wall SW1, a second side wall SW2 and a first opening OP1. When viewed along the optical axis OX, the first side wall SW1 is located on one side of the first optical element OE1. When viewed along the optical axis OX, the second side wall SW2 is located on the other side of the first optical element OE1. When viewed along the optical axis OX, the first optical element OE1 is located between the first side wall SW1 and the second side wall SW2.

In addition, the first opening OP1 corresponds to the first optical element OE1, and when viewed along the first axis AX1 (FIG. 4), at least a portion of the first optical element OE1 is exposed from the first opening OP1. The first axis AX1 is not parallel to the optical axis OX, for example, perpendicular to the optical axis OX.

As shown in FIG. 2, the movable part 108 further includes a top wall FSW and a second opening OP2. The top wall FSW corresponds to the second optical element OE2, and the second opening OP2 corresponds to the second optical element OE2 and is located on the top wall FSW. The optical axis OX passes through the second opening OP2, and the second opening OP2 is communicated with the first opening OP1.

The movable part 108 further includes a third side wall SW3 and a fourth side wall SW4. The third side wall SW3 is connected between the first side wall SW1 and the top wall FSW, and the fourth side wall SW4 is connected between the second side wall SW2 and the top wall FSW. When viewed along the first axis AX1, the third side wall SW3 and the fourth side wall SW4 each have an L-shaped structure.

In this embodiment, the outer frame 102 of the fixed assembly FA includes a third opening OP3. The third opening OP3 corresponds to the second optical element OE2, and the third opening OP3 also corresponds to the first optical element OE1. As shown in FIG. 5, when viewed along the optical axis OX, the third opening OP3 is larger than the second opening OP2.

As shown in FIG. 2, the outer frame 102 has a first outer wall 102FW and a second outer wall 102TW, and the first outer wall 102FW and the second outer wall 102TW each have a plate-shaped structure.

Specifically, the aforementioned third opening OP3 is formed by the first outer wall 102FW and the second outer wall 102TW, and the first outer wall 102FW and the second outer wall 102TW are perpendicular to each other. That is, the third opening OP3 may have an L-shaped structure.

In addition, the base 112 includes a base plate 1120 which has a plate-shaped structure, and the base 112 of the fixed assembly FA further includes a first supporting portion 1121 which is disposed on the base 112 to accommodate and support the first optical element OE1. Specifically, the first supporting portion 1121 extends from the base plate 1120 along the first axis AX1, and the first optical element OE1 is fixedly connected to the first supporting portion 1121 of the fixed assembly FA.

As shown in FIG. 3, the aforementioned external light LT is incident on the third opening OP3 in a first direction D1, is reflected by the first optical element OE1, and then is emitted from the third opening OP3 in a second direction D2. The first direction D1 and the second direction D2 are not parallel to each other, for example, they are perpendicular to each other. In addition, the first direction D1 is parallel to the first axis AX1.

In addition, in this embodiment, the movable part 108 is movable relative to the first optical element OE1 and the base 112. Furthermore, as shown in FIG. 2 and FIG. 4, a first surface SF1 of the first side wall SW1 faces the first optical element OE1, and a second surface SF2 of the first side wall SW1 and the first surface SF1 face in opposite direction.

As shown in FIG. 4, there is a gap GP1 between the first surface SF1 and the base 112 of the fixed assembly FA, and there is a gap GP2 between the second surface SF2 and the outer frame 102 of the fixed assembly FA.

Similarly, a third surface SF3 of the second side wall SW2 faces the first optical element OE1, and a fourth surface SF4 of the second side wall SW2 and the third surface SF3 face in opposite directions.

There is a gap GP3 between the third surface SF3 and the base 112 of the fixed assembly FA, there is a gap GP4 between the fourth surface SF4 and the outer frame 102 of the fixed assembly FA, and the third surface SF3 faces the first surface SF1. Based on this design, when the movable part 108 moves relative to the base 112, the movable part 108 does not collide with the base 112 or the outer frame 102.

In addition, as shown in FIG. 2 and FIG. 4, the movable part 108 further includes a rear side wall RSW which is connected between the first side wall SW1 and the second side wall SW2. When viewed along the first axis AX1, there is a gap GP5 between the rear side wall RSW and the outer frame 102.

When viewed along the first axis AX1, the movable part 108 encloses the first optical element OE1, and based on the above design, when the movable part 108 is movable relative to the first optical element OE1, the movable part 108 does not directly contact the base 112.

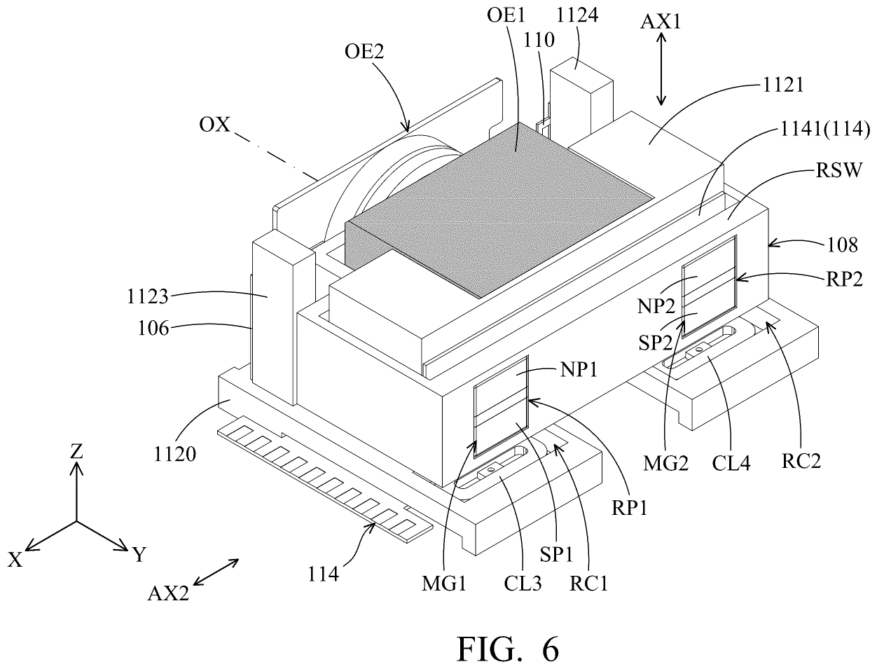

Please refer to FIG. 2 to FIG. 6. FIG. 6 is a perspective view of a partial structure of the optical module 100A in another view according to an embodiment of the present disclosure. In this embodiment, a first accommodation perforation RP1 and a second accommodation perforation RP2 are formed on the rear side wall RSW, and the driving assembly DA includes a first driving element MG1 and a second driving element MG2, which are respectively fixedly disposed in the first accommodation perforation RP1 and the second accommodation perforation RP2.

As shown in FIG. 4, when viewed along the first axis AX1, the first driving element MG1 and the second driving element MG2 are not exposed from the rear side wall RSW. As shown in FIG. 6, when viewed along the optical axis OX, the first driving element MG1 and the second driving element MG2 are exposed from the rear side wall RSW.

In this embodiment, the first driving element MG1 and the second driving element MG2 can be magnets. The North-pole NP1 and South-pole SP1 of the first driving element MG1 are arranged along the first axis AX1, and the North-pole NP2 and South-pole SP2 of the second driving element MG2 are also arranged along the first axis AX1.

Furthermore, as shown in FIG. 2 and FIG. 4, the optical module 100A of the optical element driving mechanism 100 further includes a circuit assembly 114 which is fixedly disposed on the base 112 of the fixed assembly FA. The circuit assembly 114 is a flexible circuit board (FPC board), having a first circuit portion 1141 which is fixedly disposed on the first supporting portion 1121 and faces the rear side wall RSW.

The driving assembly DA further includes a first coil CL1 and a second coil CL2, which are disposed on the first circuit portion 1141 and correspond to the first driving element MG1 and the second driving element MG2 respectively. As shown in FIG. 2, when viewed along the optical axis OX, the first circuit portion 1141 has a T-shaped structure.

In addition, as shown in FIG. 4, when viewed along the first axis AX1, the first coil CL1 and the second coil CL2 are located between the movable part 108 and the first supporting portion 1121. When viewed along the first axis AX1, the first coil CL1 and the second coil CL2 are arranged along a second axis AX2 (the X-axis). The second axis AX2 is perpendicular to the first axis AX1 and the optical axis OX.

The circuit assembly 114 further has a second circuit portion 1142 which is connected to the first circuit portion 1141. The first circuit portion 1141 may be formed by bending the second circuit portion 1142, for example, but it is not limited thereto.

The driving assembly DA may further include a third coil CL3 and a fourth coil CL4, which are disposed on the second circuit portion 1142 and correspond to the first driving element MG1 and the second driving element MG2 respectively.

As shown in FIG. 4, when viewed along the first axis AX1, the third coil CL3 and the fourth coil CL4 are arranged along the second axis AX2. When viewed along the first axis AX1, the rear side wall RSW overlaps a portion of the third coil CL3 and the fourth coil CL4.

When viewed along the first axis AX1, the first coil CL1 overlaps a portion of the third coil CL3. When viewed along the first axis AX1, the second coil CL2 overlaps a portion of the fourth coil CL4.

As shown in FIG. 6, when viewed along the second axis AX2, the third coil CL3 and the fourth coil CL4 are located between the circuit assembly 114 and the movable part 108. Specifically, a first accommodation hole RC1 and a second accommodation hole RC2 are formed on the base plate 1120 to respectively accommodate the third coil CL3 and the fourth coil CL4.

The first accommodation hole RC1 and the second accommodation hole RC2 penetrate the base plate 1120, and when viewed along the first axis AX1, the rear side wall RSW overlaps the first accommodation hole RC1 and the second accommodation hole RC2.

When viewed along the first axis AX1, the first coil CL1 and the third coil CL3 are symmetrical to the second coil CL2 and the fourth coil CL4. When viewed along the first axis AX1, the long side of the first coil CL1 and the long side of the third coil CL3 extend along the second axis AX2.

When viewed along the first axis AX1, the length LH1 of the first coil CL1 along the second axis AX2 is different from the length LH3 of the third coil CL3 along the second axis AX2. For example, when viewed along the first axis AX1, the length LH1 of the first coil CL1 along the second axis AX2 is smaller than the length LH3 of the third coil CL3 along the second axis AX2.

When viewed along the first axis AX1, the length LH5 of the first driving element MG1 along the second axis AX2 is different from the length LH1 of the first coil CL1 along the second axis AX2. For example, when viewed along the first axis AX1, the length LH5 of the first driving element MG1 along the second axis AX2 is smaller than the length LH1 of the first coil CL1 along the second axis AX2.

Similarly, the length LH2 of the second coil CL2 along the second axis AX2 is less than the length LH4 of the fourth coil CL4 along the second axis AX2, and the length LH6 of the second driving element MG2 along the second axis AX2 is less than the length LH2 of the second coil CL2 along the second axis AX2.

In addition, when viewed along the first axis AX1, the width WT1 of the rear side wall RSW along the optical axis OX is different from the width WT2 of the third coil CL3 along the optical axis OX. When viewed along the first axis AX1, the width WT1 of the rear side wall RSW along the optical axis OX is smaller than the width WT2 of the third coil CL3 along the optical axis OX.

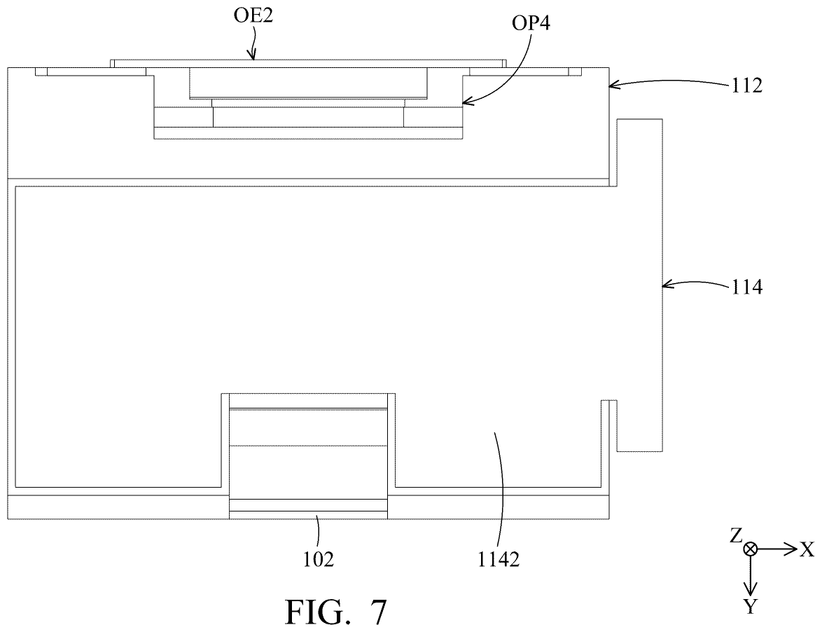

Next, please refer to FIG. 4 and FIG. 7, which is a bottom view of the first optical module 100A according to an embodiment of the present disclosure. As shown in FIG. 4 and FIG. 7, the base 112 of the fixed assembly FA further includes a fourth opening OP4 corresponding to the second optical element OE2.

As shown in FIG. 4, when viewed along the first axis AX1, the third opening OP3 overlaps at least portion of the fourth opening OP4, and the fourth opening OP4 is located at the base 112 (that is, formed by the base 112). As shown in FIG. 4, when viewed along the first direction D1, a portion of the first optical element OE1 is exposed from the third opening OP3. When viewed along the first direction D1, a portion of the second optical element OE2 is exposed from the third opening OP3.

As shown in FIG. 2 and FIG. 7, when viewed along a third direction D3, the first optical element OE1 is not exposed from the fourth opening OP4, and a portion of the second optical element OE2 is exposed from the fourth opening OP4. The third direction D3 is opposite to the first direction D1.

Next, as shown in FIG. 2, in this embodiment, the optical element driving mechanism 100 further includes a connecting assembly CA, so that the movable part 108 is movably connected to the fixed assembly FA through the connecting assembly CA. The connecting assembly CA may include a first elastic member 106 and a second elastic member 110.

Specifically, as shown in FIG. 5, the first elastic member 106 and the second elastic member 110 respectively have a first flexible portion 1063 and a second flexible portion 1103, the first flexible portion 1063 has flexibility, and the second flexible portion 1103 has flexibility.

As shown in FIG. 5, when viewed along the optical axis OX, the first flexible portion 1063, the first optical element OE1, and the second flexible portion 1103 are arranged along a second axis AX2.

When viewed along the optical axis OX, a longitudinal axis LX of the movable part 108 having a long strip-shaped structure is parallel to the second axis AX2. When viewed along the optical axis OX, the first flexible portion 1063 and the second flexible portion 1103 are arranged along the second axis AX2. When viewed along the optical axis OX, the center of the second optical element OE2 is located between the first flexible portion 1063 and the second flexible portion 1103.

Furthermore, as shown in FIG. 5, the first elastic member 106 further has a first connecting end 1061 which is fixedly connected to the base 112 of the fixed assembly FA. Specifically, the first connecting end 1061 is affixed to a first setting portion 1123 of the fixed assembly FA.

Similarly, the first elastic member 106 further has a second connecting end 1062 which is fixedly connected to the top wall FSW of the movable part 108, and the first flexible portion 1063 is connected between the first connecting end 1061 and the second connecting end 1062.

Similarly, the second elastic member 110 may have a third connecting end 1101 which is fixedly connected to the base 112 of the fixed assembly FA. Specifically, the third connecting end 1101 is affixed to a second setting portion 1124 of the fixed assembly FA.

The second elastic member 110 further has a fourth connecting end 1102 which is fixedly connected to the top wall FSW of the movable part 108, and the second flexible portion 1103 is connected between the third connecting end 1101 and the fourth connecting end 1102.

As shown in FIG. 5, when viewed along the optical axis OX, the first setting portion 1123, the second optical element OE2 and the second setting portion 1124 are arranged along the second axis AX2.

As shown in FIG. 2 and FIG. 4, the third side wall SW3 and the fourth side wall SW4 each has a recessed structure, and the third side wall SW3 and the fourth side wall SW4 respectively correspond to the first setting portion 1123 and Second setting portion 1124.

The first setting portion 1123 and the second setting portion 1124 each has a columnar structure extending along the first axis AX1 from the base plate 1120, and the first setting portion 1123 and the second setting portion 1124 do not contact the movable part 108 and the first supporting portion 1121.

It should be noted that the first setting portion 1123, the second setting portion 1124, the first supporting portion 1121 and the base plate 1120 are integrally formed in one piece, but they are not limited thereto. In addition, as shown in FIG. 4, when viewed along the first axis AX1, in the direction of the optical axis OX or the second axis AX2, the third side wall SW3 is located between the first setting portion 1123 and the first supporting portion 1121, and the fourth side wall SW4 is located between the second setting portion 1124 and the first supporting portion 1121.

Moreover, it is worth noting that, as shown in FIG. 5, when viewed along the optical axis OX, the first optical module 100A of the optical element driving mechanism 100 does not include any flexible portion which is arranged with the second optical element OE2 along the first axis AX1 (for example, a flexible portion similar to the first flexible portion 1063). Therefore, such a configuration can significantly reduce the height of the optical element driving mechanism 100 along the Z-axis so as to achieve the purpose of thinning.

In addition, in this embodiment, the first optical element OE1 and the second optical element OE2 may be made of different materials. For example, the first optical element OE1 and the second optical element OE2 may be in different material states. Specifically, the second optical element OE2 can be a liquid lens, and the first optical element OE1 can be a solid lens, but they are not limited thereto.

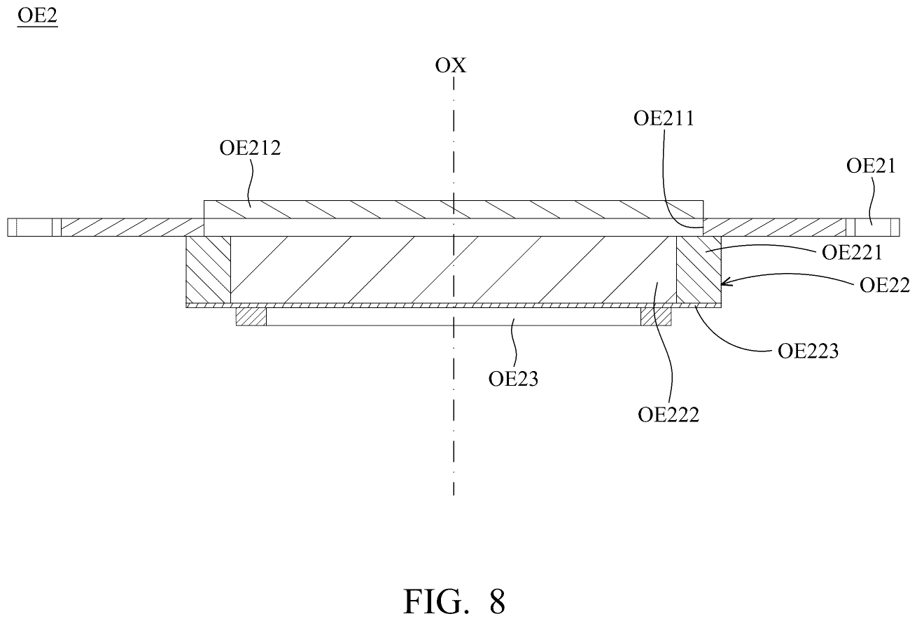

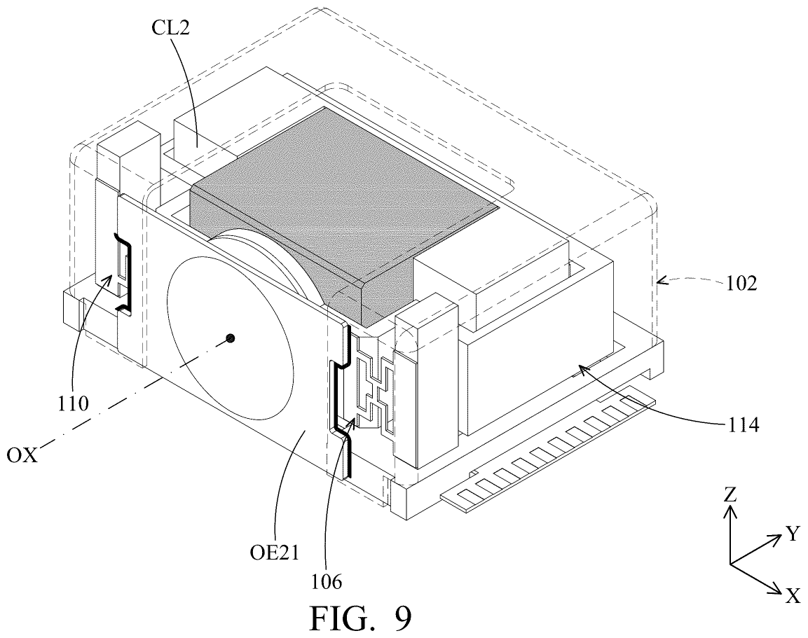

Next, please refer to FIG. 8 and FIG. 9. FIG. 8 is a cross-sectional view of the second optical element OE2 along line B-B in FIG. 5 according to an embodiment of the present disclosure, and FIG. 9 is a perspective view of the first optical module 100A according to an embodiment of the present disclosure. In this embodiment, the second optical element OE2 may include an optical fixed portion OE21, a main body OE22 and a pushing portion OE23.

As shown in FIG. 8 and FIG. 9, the optical fixed portion OE21 has a plate-shaped structure which is fixedly connected to the outer frame 102 of the fixed assembly FA. For example, the optical fixed portion OE21 and the outer frame 102 are both made of metal material, so that the optical fixed portion OE21 can be affixed to the outer frame 102 of the fixed assembly FA by laser welding (the position of the laser welding is shown by the bold lines in the figures). It is important to note that the optical fixed portion OE21 is not elastic or flexible.

In addition, as shown in FIG. 8, when viewed along the optical axis OX, the optical fixed portion OE21 overlaps at least portion of the connecting assembly CA, such as overlapping the first elastic member 106 and the second elastic member 110.

Furthermore, the optical fixed portion OE21 has an optical opening OE211, so that the aforementioned external light LT can pass through the main body OE22 along the optical axis OX. The optical fixed portion OE21 may further have a translucent element OE212, such as a lens, which is fixedly disposed on the optical fixed portion OE21.

The main body OE22 may have an accommodation frame OE221 to accommodate the liquid OE222 therein, and a thin film OE223 is provided on the bottom of the accommodation frame OE221 to seal the liquid OE222 within the accommodation frame OE221.

Furthermore, the pushing portion OE23 has a ring-shaped structure which is fixedly connected to the movable part 108 and the thin film OE223 and located between the movable part 108 and the thin film OE223. The pushing portion OE23 can be driven by the movable part 108 to push the thin film OE223 and the liquid OE222.

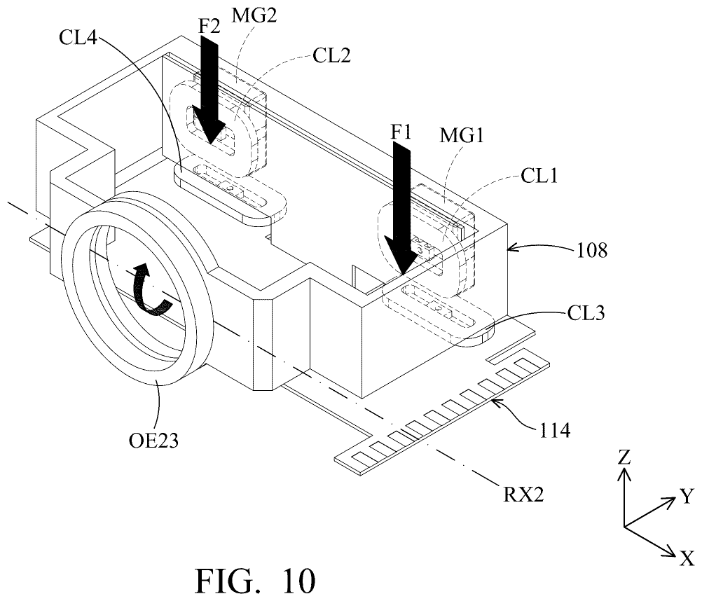

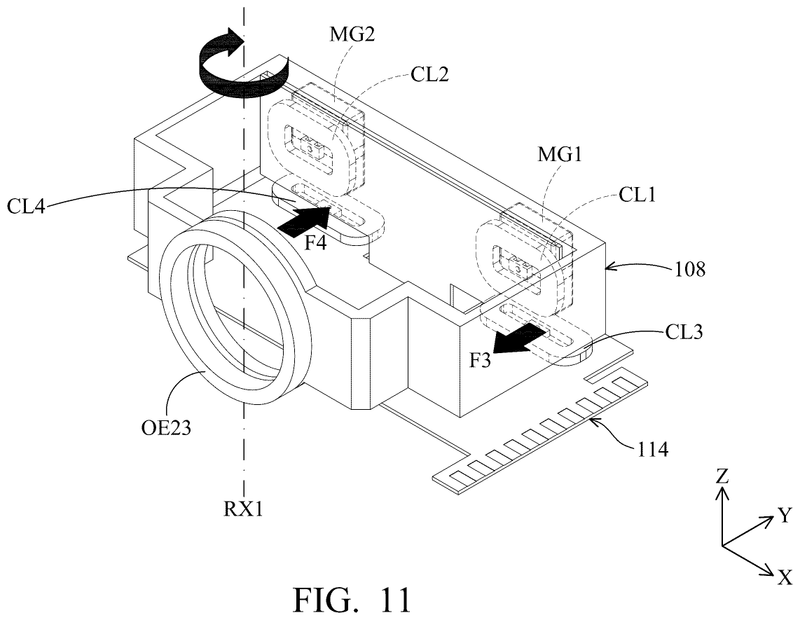

Next, please refer to FIG. 8 to FIG. 11. FIG. 10 and FIG. 11 are schematic three-dimensional diagrams illustrating that the driving assembly DA drives the movable part 108 to rotate around different axes according to an embodiment of the present disclosure. In this embodiment, the first driving element MG1 and the second driving element MG2 are configured to drive the movable part 108 to rotate around a first rotation axis RX1 or a second rotation axis RX2, so that the pushing part OE23 pushes the main body OE22 to change the optical property of the second optical element OE2.

For example, as shown in FIG. 10, when the first coil CL1 and the second coil CL2 act with the first driving element MG1 and the second driving element MG2 respectively to generate the electromagnetic driving forces F1 and F2, the movable part 108 is driven to rotate around the second rotation axis RX2 relative to the base 112.

Specifically, the electromagnetic driving forces F1 and F2 are directed toward the −Z-axis, and the second rotation axis RX2 is parallel to the X-axis. As shown in FIG. 10, the movable part 108 is driven by the electromagnetic driving forces F1 and F2 to rotate around the second rotation axis RX2 relative to the base 112, and the first setting portion 1123 and the second setting portion 1124 of the base 112 respectively serve as support points for the first elastic member 106 and the second elastic member 110, so that the movable part 108 performs a Nose-up motion around the second rotation axis RX2. On the contrary, when the electromagnetic driving forces F1 and F2 are directed toward the +Z-axis, the movable part 108 can be driven to perform a Nose-down motion.

On the other hand, as shown in FIG. 11, when the third coil CL3 and the fourth coil CL4 act with the first driving element MG1 and the second driving element MG2 respectively to generate the electromagnetic driving forces F3 and F4, the first driving element MG1 and the second driving element MG2 drive the movable part 108 to rotate around the first rotation axis RX1 relative to the base 112. The first rotation axis RX1 is perpendicular to the second rotation axis RX2.

Specifically, the electromagnetic driving force F3 is directed towards the −Y-axis and the electromagnetic driving force F4 is directed towards the +Y-axis, and the first rotation axis RX1 is parallel to the Z-axis. As shown in FIG. 11, the movable part 108 is driven by the electromagnetic driving forces F3 and F4 to rotate around the first rotation axis RX1 relative to the base 112, and the first setting portion 1123 and the second setting portion 1124 of the base 112 respectively serve as support points for the first elastic member 106 and the second elastic member 110, so that the movable part 108 performs a Yaw right motion. On the contrary, when the electromagnetic driving force F3 is directed towards the +Y-axis and the electromagnetic driving force F4 is directed towards the −Y-axis, the movable part 108 can be driven to perform a Yaw left motion.

It is worth noting that, as shown in FIG. 5, when viewed along the optical axis OX, the first rotation axis RX1 is located between the first flexible portion 1063 and the second flexible portion 1103, and the first rotation axis RX1 can intersect with the optical axis OX.

Furthermore, as shown in FIG. 5, when viewed along the optical axis OX, the second rotation axis RX2 passes through the first flexible portion 1063 and the second flexible portion 1103, and the second rotation axis RX2 can intersect with the first rotation axis RX1 and the optical axis OX, but they are not limited thereto.

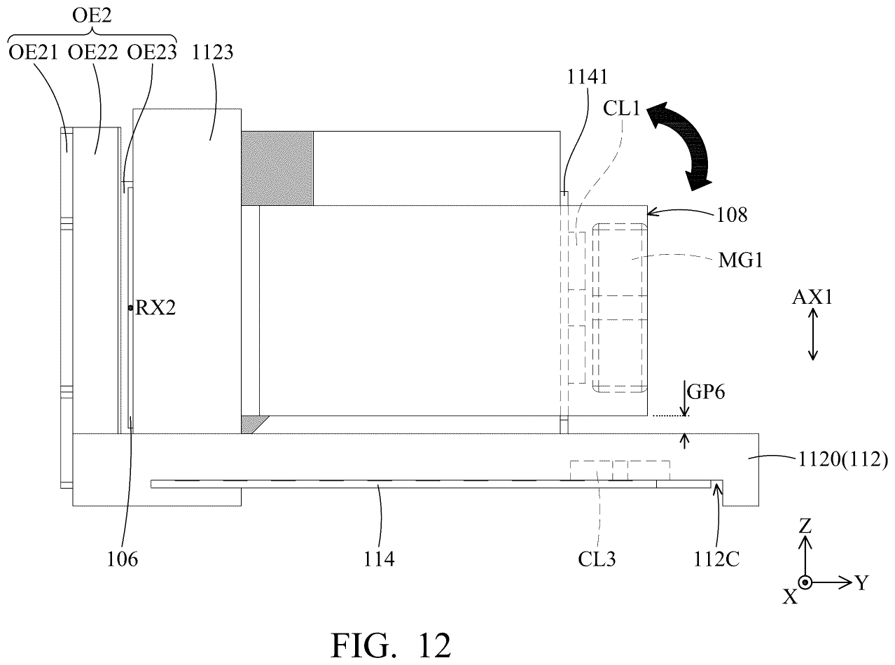

Next, please refer to FIG. 12, which is a side view of a partial structure of the first optical module 100A according to an embodiment of the present disclosure. As shown in FIG. 12, a gap GP6 is formed between the movable part 108 and the base plate 1120 along the first axis AX1. Therefore, when the movable part 108 rotates around the second rotation axis RX2, the movable part 108 does not collide with the base 112 to cause damage.

In addition, when viewed along the second axis AX2, the base plate 1120 forms a bottom groove 112C configured to accommodate a portion of the circuit assembly 114. Based on such a design, not only the circuit assembly 114 can be protected, but also the purpose of miniaturized can be achieved.

The present disclosure provides an optical element driving mechanism 100, which can be a periscope lens mechanism, including a fixed assembly FA, a driving assembly DA, a movable part 108 and a connecting assembly CA. The movable part 108 is movably connected to the base 112 of the fixed assembly FA through the connecting assembly CA, and the movable part 108 surrounds the first optical element OE1. The optical fixed portion OE21 of the second optical element OE2 is affixed to the outer frame 102 of the fixed assembly FA, and the pushing portion OE23 is fixedly connected to the movable part 108.

The driving assembly DA is configured to drive the movable part 108 to move relative to the base 112 and the first optical element OE1 to drive the pushing portion OE23 to push the thin film OE223 and the liquid OE222, thereby changing the optical properties of the second optical element OE2, so as to achieve the purpose of optical image stabilization. Because there is a gap between the movable part 108 and the base 112, the movable part 108 does not collide with the base 112 and cause damage when rotating.

It is worth noting that the driving assembly DA only includes two driving elements (the magnets), and the first coil CL1 to the fourth coil CL4 share the two driving elements. Therefore, such a configuration can reduce the overall volume of the optical element driving mechanism 100 to achieve miniaturization. In addition, because the number of magnets is reduced, the purpose of weight reduction can also be further achieved.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. An optical element driving mechanism for accommodating a first optical element and comprising:
a fixed assembly:
a movable part, configured to be connected to a second optical element, wherein the second optical element corresponds to the first optical element, and the movable part is movable relative to the fixed assembly; and
a driving assembly, configured to drive the movable part to move relative to the fixed assembly;
wherein the fixed assembly includes a first accommodating space configured to accommodate the first optical element.

2. The optical element driving mechanism as claimed in claim 1, wherein
the movable part includes a second accommodation space configured to accommodate the first optical element;
the second accommodation space is located in the first accommodation space;
the second optical element defines an optical axis;
the optical axis passes through the second optical element and the first optical element;
when viewed along the optical axis, the movable part has a long strip-shaped structure.

3. The optical element driving mechanism as claimed in claim 2, wherein
the movable part further includes a first side wall, a second side wall and a first opening;
when viewed along the optical axis, the first side wall is located on one side of the first optical element;
when viewed along the optical axis, the second side wall is located on other side of the first optical element;
when viewed along the optical axis, the first optical element is located between the first side wall and the second side wall;
the first opening corresponds to the first optical element;
when viewed along a first axis, at least a portion of the first optical element is exposed from the first opening;
the first axis is not parallel to the optical axis.

4. The optical element driving mechanism as claimed in claim 3, wherein
the movable part further includes a top wall and a second opening;
the top wall corresponds to the second optical element;
the second opening corresponds to the second optical element and is located on the top wall;
the optical axis passes through the second opening;
the movable part further includes a third side wall and a fourth side wall;
the third side wall is connected between the first side wall and the top wall;
the fourth side wall is connected between the second side wall and the top wall;
when viewed along the first axis, the third side wall and the fourth side wall each have an L-shaped structure.

5. The optical element driving mechanism as claimed in claim 4, wherein
the fixed assembly further includes a base and an outer frame;
the outer frame is fixedly connected to the base to form the first accommodation space;
the base has a base plate with a plate-shaped structure;
the fixed assembly further includes a first supporting portion which is disposed on the base to accommodate the first optical element;
the first supporting portion extends and protrudes along the first axis from the base plate;
the first optical element is fixedly connected to the first supporting portion;
the movable part is movable relative to the first optical element.

6. The optical element driving mechanism as claimed in claim 5, wherein
the movable part further includes a rear side wall which is connected between the first side wall and the second side wall;
when viewed along the first axis, there is a gap between the rear side wall and the outer frame;
when viewed along the first axis, the movable part encloses the first optical element;
the movable part does not directly contact the base.

7. The optical element driving mechanism as claimed in claim 6, wherein
a first accommodation perforation and a second accommodation perforation are formed on the rear side wall;
the driving assembly includes a first driving element and a second driving element, which are respectively arranged in the first accommodation perforation and the second accommodation perforation;
when viewed along the first axis, the first driving element and the second driving element are not exposed from the rear side wall;
when viewed along the optical axis, the first driving element and the second driving element are exposed from the rear side wall;
the first driving element and the second driving element are configured to drive the movable part to rotate around a first rotation axis or a second rotation axis, so that a pushing portion of the second optical element pushes a main body of the second optical elements to change the optical properties of the second optical element;
North-pole and South-pole of each of the first driving element and the second driving element are arranged along the first axis.

8. The optical element driving mechanism as claimed in claim 7, wherein
the optical element driving mechanism further includes a circuit assembly fixedly disposed on the base of the fixed assembly;
the circuit assembly has a first circuit portion which is fixedly disposed on the first supporting portion and faces the rear side wall;
the driving assembly further includes a first coil and a second coil, which are disposed on the first circuit portion and respectively correspond to the first driving element and the second driving element;
when viewed along the optical axis, the first circuit portion has a t-shaped structure;
when viewed along the first axis, the first coil and the second coil are located between the movable part and the first supporting portion;
when viewed along the first axis, the first coil and the second coil are arranged along a second axis;
the second axis is perpendicular to the first axis and the optical axis.

9. The optical element driving mechanism as claimed in claim 8, wherein
the circuit assembly further has a second circuit portion which is connected to the first circuit portion;
the driving assembly further includes a third coil and a fourth coil, which are disposed on the second circuit portion and respectively correspond to the first driving element and the second driving element;
when viewed along the second axis, the third coil and the fourth coil are located between the circuit assembly and the movable part;
when viewed along the first axis, the third coil and the fourth coil are arranged along the second axis;
when viewed along the first axis, the rear side wall overlaps a portion of the third coil and the fourth coil;
when viewed along the first axis, the first coil overlaps a portion of the third coil;
when viewed along the first axis, the second coil overlaps a portion of the fourth coil.

10. The optical element driving mechanism as claimed in claim 9, wherein
when the first coil and the second coil respectively act with the first driving element and the second driving element, the first driving element and the second driving element drive the movable part to rotate around the second rotation axis relative to the base;
when the third coil and the fourth coil respectively act with the first driving element and the second driving element, the first driving element and the second driving element drive the movable part to rotate around the first rotation axis relative to the base;
the first rotation axis is perpendicular to the second rotation axis.

11. The optical element driving mechanism as claimed in claim 10, wherein
a first accommodation hole and a second accommodation hole are formed on the base plate and respectively accommodate the third coil and the fourth coil;
the first accommodation hole and the second accommodation hole penetrate the base plate;
when viewed along the first axis, the rear side wall overlaps the first accommodation hole and the second accommodation hole;
when viewed along the first axis, the first coil and the third coil are symmetrical to the second coil and the fourth coil.

12. The optical element driving mechanism as claimed in claim 11, wherein
when viewed along the first axis, a long side of the first coil and a long side of the third coil extend along the second axis;
when viewed along the first axis, a length of the first coil along the second axis is different from a length of the third coil along the second axis;
when viewed along the first axis, the length of the first coil along the second axis is less than the length of the third coil along the second axis;
when viewed along the first axis, a length of the first driving element along the second axis is different from a length of the first coil along the second axis;
when viewed along the first axis, the length of the first driving element along the second axis is less than the length of the first coil along the second axis.

13. The optical element driving mechanism as claimed in claim 12, wherein
when viewed along the first axis, a width of the rear side wall along the optical axis is different from a width of the third coil along the optical axis;
when viewed along the first axis, the width of the rear side wall along the optical axis is smaller than the width of the third coil along the optical axis;
when viewed along the second axis, a gap is formed between the movable part and the base plate along the first axis;
when viewed along the second axis, the base plate forms a bottom groove configured to accommodate a portion of the circuit assembly.

14. The optical element driving mechanism as claimed in claim 13, wherein
the optical element driving mechanism further includes a connecting assembly, and the movable part is movably connected to the fixed assembly through the connecting assembly;
the connecting assembly includes a first elastic member and a second elastic member;
the first elastic member and the second elastic member respectively have a first flexible portion and a second flexible portion;
the first flexible portion has flexibility;
the second flexible portion has flexibility;
when viewed along the optical axis, the first flexible portion and the first optical element are arranged along the second axis;
when viewed along the optical axis, a longitudinal axis of the movable part having a long strip-shaped structure is parallel to the second axis;
when viewed along the optical axis, the first flexible portion and the second flexible portion are arranged along the second axis;
when viewed along the optical axis, a center of the second optical element is located between the first flexible portion and the second flexible portion.

15. The optical element driving mechanism as claimed in claim 14, wherein
the first elastic member has a first connecting end which is fixedly connected to the fixed assembly;
the first connecting end is affixed to a first setting portion of the fixed assembly;
the first elastic member further has a second connecting end which is fixedly connected to the movable part;
the first flexible portion is connected between the first connecting end and the second connecting end;
the second elastic member has a third connecting end which is fixedly connected to the fixed assembly;
the third connecting end is affixed to a second setting portion of the fixed assembly;
the second elastic member further has a fourth connecting end which is fixedly connected to the movable part;
the second flexible portion is connected between the third connecting end and the fourth connecting end.

16. The optical element driving mechanism as claimed in claim 15, wherein
when viewed along the optical axis, the first setting portion, the second optical element and the second setting portion are arranged along the second axis;
the third side wall and the fourth side wall each has a recessed structure;
the third side wall and the fourth side wall respectively correspond to the first setting portion and the second setting portion;
the first setting portion and the second setting portion each has a columnar structure extending along the first axis from the base plate;
the first setting portion and the second setting portion do not contact the movable part and the first supporting portion;
the first setting portion, the second setting portion, the first supporting portion and the base plate are integrally formed in one piece;
when viewed along the first axis, in the direction of the optical axis or the second axis, the third side wall is located between the first setting portion and the first supporting portion, and the fourth side wall is located between the second setting portion and the first supporting portion.

17. The optical element driving mechanism as claimed in claim 16, wherein
when viewed along the optical axis, the first rotation axis is located between the first flexible portion and the second flexible portion;
when viewed along the optical axis, the second rotation axis passes through the first flexible portion and the second flexible portion;
the first optical element and the second optical element have different materials;
the first optical element and the second optical element have different material states;
the second optical element is a liquid lens;
the first optical element includes a solid lens;
the second optical element further includes an optical fixed portion;
the optical fixed portion is fixedly connected to the fixed assembly;
the optical fixed portion is affixed to the fixed assembly by laser welding;
the optical axis passes through the main body;
the pushing portion has a ring-shaped structure;
the pushing portion is fixedly connected to the movable part;
when viewed along the optical axis, the optical fixed portion overlaps at least a portion of the connecting assembly.

18. The optical element driving mechanism as claimed in claim 17, wherein
the fixed assembly further includes a third opening;
the third opening corresponds to the second optical element;
the third opening corresponds to the first optical element;
when viewed along the optical axis, the third opening is larger than the second opening.

19. The optical element driving mechanism as claimed in claim 18, wherein
the outer frame has a first outer wall and a second outer wall;
the first outer wall and the second outer wall each have a plate-shaped structure;
the third opening is formed by the first outer wall and the second outer wall;
the first outer wall and the second outer wall are perpendicular to each other;
an external light is incident on the third opening in a first direction and is emitted from the third opening in a second direction;
the first direction and the second direction are not parallel to each other.

20. The optical element driving mechanism as claimed in claim 19, wherein
a first surface of the first side wall faces the first optical element;
a second surface of the first side wall and the first surface face in opposite directions;
there is a gap between the first surface and the fixed assembly;
there is another gap between the second surface and the fixed assembly;
a third surface of the second side wall faces the first optical element;
a fourth surface of the second side wall and the third surface face in opposite directions;
there is another gap between the third surface and the fixed assembly;
there is another gap between the fourth surface and the fixed assembly;
the third surface faces the first surface;
the fixed assembly further includes a fourth opening corresponding to the second optical element;
when viewed along the first axis, the third opening overlaps at least a portion of the fourth opening;
the fourth opening is located at the base.
